(19) United States
(12) Patent Application Publication
(10) Pub. No.: US 2025/0021280 A1
(43) Pub. Date: Jan. 16, 2025

(54) CONVEYANCE CONTROL DEVICE, CONTROL METHOD OF CONVEYANCE CONTROL DEVICE, AND NON-TRANSITORY COMPUTER READABLE MEDIUM

(71) Applicant: BROTHER KOGYO KABUSHIKI KAISHA, Nagoya (JP)

(72) Inventors: Shota MORIKAWA, Nagoya (JP); Kodai MIZUNO, Hekinan (JP); Hitomi MIWA, Nagoya (JP)

(21) Appl. No.: 18/901,152

(22) Filed: Sep. 30, 2024

Related U.S. Application Data
(63) Continuation of application No. PCT/JP2023/010592, filed on Mar. 17, 2023.

(30) Foreign Application Priority Data
Mar. 30, 2022 (JP) 2022-057204

(51) Int. Cl. G06F 3/12; B41J 3/54; B41J 11/06; B41J 11/14; B41J 29/00

(52) U.S. Cl. CPC G06F 3/1261; B41J 3/543; B41J 11/06; B41J 11/14; B41J 29/00; G06F 3/1208; G06F 3/1253; G06F 3/1273; G06F 3/1281

(57) ABSTRACT

A conveyance control device includes a memory, and a processor configured to control a conveyance device in a printing system. The printing system includes a plurality of printers, each of the printers being configured to perform printing on a recording medium based on print data, and the conveyance device configured to convey, to any one of the plurality of printers, a platen on which the recording medium is placed. The memory is configured to store computer-readable instructions that, when executed by the processor, cause the processor to perform processes including receiving second print data included in the print data, and determining, among the plurality of printers, an execution printer that is a printer performing printing based on the second print data, based on the received second print data and history information stored in a storage.

### REFERENCE TO RELATED APPLICATIONS

This is a continuation application of International Application No. PCT/JP2023/010592 filed on Mar. 17, 2023, which claims priority from Japanese Patent Application No. 2022-057204 filed on Mar. 30, 2022. The entire contents of the aforementioned applications are incorporated herein by reference.

### BACKGROUND ART

In the related art, as a printing device that prints an image on a recording medium, for example, a printing device described below is known. The printing device prints an image by discharging a printing liquid onto a recording medium placed on a tray which is a platen.

In order to enhance a processing capability of printing, it is conceivable to construct a printing system in which a plurality of printing devices are provided and the platen on which the recording medium is placed is conveyed to any of the printing devices, according to a print job to be executed. However, for example, even in a case where the plurality of printing devices of the same model are prepared, a reproducible color gamut may be different for each printing device. Therefore, in a case where the same image is printed by different printing devices, there is a possibility that a difference in color of an obtained image occurs.

An object of the present disclosure is to provide a conveyance control device, a control method thereof, and a non-transitory computer readable storage medium storing a computer program capable of further improving color reproducibility of a printed image in a case where the same job is executed and where a platen is conveyed to a plurality of printers.

### SUMMARY

A conveyance control device including: a memory, and a processor configured to control a conveyance device in a printing system, the printing system including: a plurality of printers, each of the printers being configured to perform printing on a recording medium based on print data; and the conveyance device configured to convey, to any one of the plurality of printers, a platen on which the recording medium is placed; in which the memory is configured to store computer-readable instructions that, when executed by the processor, cause the processor to perform processes including: receiving second print data included in the print data; and determining, among the plurality of printers, an execution printer that is a printer performing printing based on the second print data, based on the received second print data and history information stored in a storage, the storage being configured to store the history information in which first print data and the printer are associated with each other, the first print data being included in the print data, the printer performing the printing based on the first print data.

A control method of a conveyance control device, the conveyance control device including: a processor configured to control a conveyance device in a printing system, the printing system including: a plurality of printers, each of the printers being configured to perform printing on a recording medium based on print data; and the conveyance device configured to convey, to any one of the plurality of printers, a platen on which the recording medium is placed, the control method including: receiving second print data included in the print data; and determining, among the plurality of printers, an execution printer that is a printer performing printing based on the second print data, based on the received second print data and history information stored in a storage, the storage being configured to store the history information in which first print data and the printer are associated with each other, the first print data being included in the print data, the printer performing the printing based on the first print data.

A non-transitory computer readable storage medium storing a computer program executed by a processor in a conveyance control device including: the processor configured to control a conveyance device in a printing system, the printing system including: a plurality of printers, each of the printers being configured to perform printing on a recording medium based on print data; and the conveyance device configured to convey, to any one of the plurality of printers, a platen on which the recording medium is placed, the computer program causing the processor to: receive second print data included in the print data; and determine, among the plurality of printers, an execution printer that is a printer performing printing based on the second print data, based on the received second print data and history information stored in a storage, the storage being configured to store the history information in which first print data and the printer are associated with each other, the first print data being included in the print data, the printer performing the printing based on the first print data.

### BRIEF DESCRIPTION OF DRAWINGS

FIG. 1 is a schematic plan view showing a schematic configuration of a printing system.

FIG. 2 is a block diagram showing a functional configuration of the printing system.

FIG. 3 is a flowchart showing an operation example of a conveyance control device in an image quality priority mode.

FIG. 4 is a table showing an example of a case where an execution printer is determined in the image quality priority mode.

FIG. 5 is a flowchart showing an operation example of the conveyance control device in a speed priority mode.

FIG. 6A is a table showing comparison results of color gamuts among a plurality of printers.

FIG. 6B is a table showing substitution ranks among the plurality of printers.

FIG. 7 is a table showing an example in which the execution printer and an alternative printer are determined in the speed priority mode.

FIG. 8 is a flowchart showing an operation example of the conveyance control device in a compromise mode.

FIG. 9 is a flowchart showing an operation example of the conveyance control device in a user selection mode.

FIG. 10A is a table for illustrating required time when a series of print jobs are executed in the image quality priority mode.

FIG. 10B is a time chart for illustrating required time when a series of print jobs are executed in the image quality priority mode.

FIG. 11A is a table for illustrating required time when the series of print jobs are executed in the speed priority mode.

FIG. 11B is a table and a time chart for illustrating required time when the series of print jobs are executed in the speed priority mode.

### DESCRIPTION

Embodiments according to the present disclosure will be described with reference to the drawings.

### <Printing System>

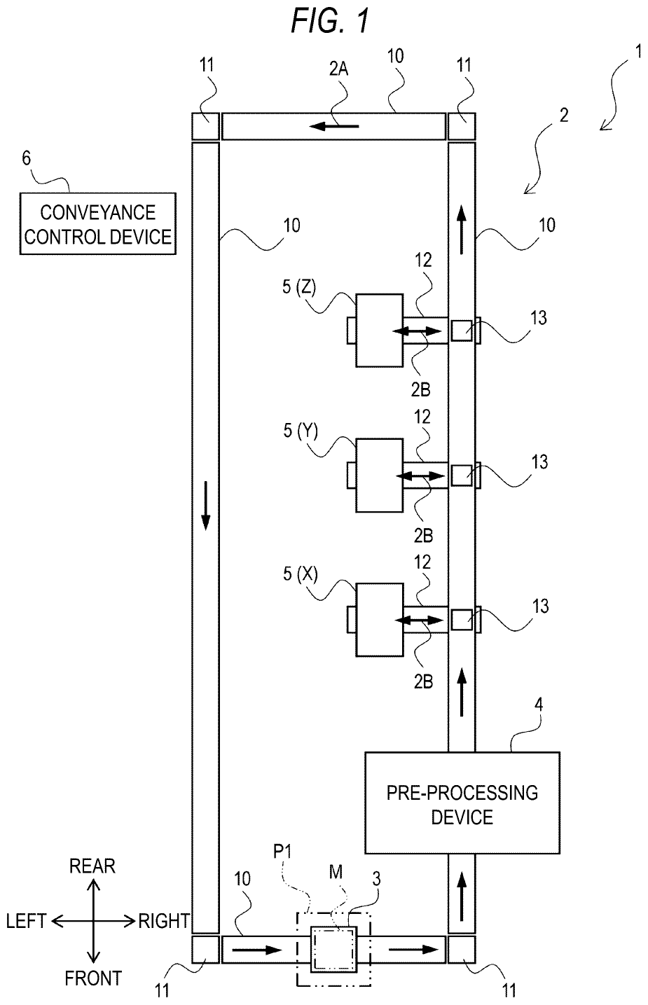

FIG. 1 is a schematic plan view showing a schematic configuration of a printing system 1. The printing system 1 shown in FIG. 1 includes a conveyance device 2, a platen 3, a pre-processing device 4, a plurality of printers 5, and a conveyance control device 6. In the following description, front-rear and left-right directions indicated by arrows in FIG. 1 and an upper-lower direction intersecting with both of the directions are used.

As an example, the conveyance device 2 is configured to sequentially convey the platen 3 supporting a recording medium M from a predetermined start position P1 to the pre-processing device 4 and one of the printers 5, and then configured to return the platen 3 to the start position P1. For this purpose, the conveyance device 2 includes a circulation line 2A configured to convey the platen 3 in a predetermined forward direction (counterclockwise direction in FIG. 1) with the start position P1 as a base point, and a plurality of linear branch lines 2B extending from the middle of the circulation line 2A.

The circulation line 2A is configured to form a rectangular circulation path having linearly motion type first conveyance mechanisms 10 as four sides, in which four sets of the first conveyance mechanisms 10 each including an endless belt and a belt motor for driving the endless belt is combined, for example. In the example of FIG. 1, the pair of conveyance mechanisms 10 extending in the left-right direction and the pair of conveyance mechanisms 10 extending in the front-rear direction are combined, and the start position P1 is provided in the middle of one conveyance mechanism 10 located at the foremost position and extending in the left-right direction.

A first transfer mechanism 11 for transferring the platen 3 from one side to the other side is provided at a connection portion between the two adjacent conveyance mechanisms 10. Further, a configuration of the circulation line 2A is not limited thereto, and a curved conveyor belt or a roller conveyor may be used.

In the example of FIG. 1, the plurality of branch lines 2B extend from the middle of one conveyance mechanism 10 that is located on a right side and extends in the front-rear direction. The branch line 2B is formed as a linear path by a linear motion type second conveyance mechanism 12 including an endless belt and a belt motor for driving the endless belt, for example. A base end portion of the second conveyance mechanism 12 is connected to a position in the middle of the first conveyance mechanism 10 and extends in a left direction intersecting a longitudinal direction of the first conveyance mechanism 10. In the example of FIG. 1, three branch lines 2B are provided.

A second transfer mechanism 13 for transferring the platen 3 from one side to the other side is provided at a connection portion between the first conveyance mechanism 10 and the second conveyance mechanism 12. Further, a configuration of the branch lines 2B is not limited thereto, and another configuration such as a roller conveyor may be adopted.

The pre-processing device 4 is provided on the circulation line 2A between the start position P1 and the branch line 2B closest to the start position P1 in a forward direction. The pre-processing device 4 is a device configured to perform predetermined processing on the print medium M supported by the platen 3 before printing. Therefore, the pre-processing device 4 includes, for example, a coating device and a heat treatment device. The coating device has a spray configured to spray a coating agent or the like, as a pre-processing liquid for enhancing color development of ink printed on the print medium M. The heat treatment device includes a heater configured to generate heat for fixing the coating agent sprayed on the print medium M, a press machine maintained at a predetermined high temperature, or the like.

The printer 5 is provided at a leading end portion (left end portion) of each second conveyance mechanism 12. The printer 5 is an inkjet printer configured to eject ink from a head to perform printing (form an image) on the recording medium M on the platen 3 conveyed along the branch line 2B, based on print data. In the example of FIG. 1, three printers 5 (printers X, Y, and Z) are provided as many as the branch lines 2B. Further, the conveyance control device 6 is configured to control an operation of the conveyance device 2, the pre-processing device 4, the printer 5, and the like.

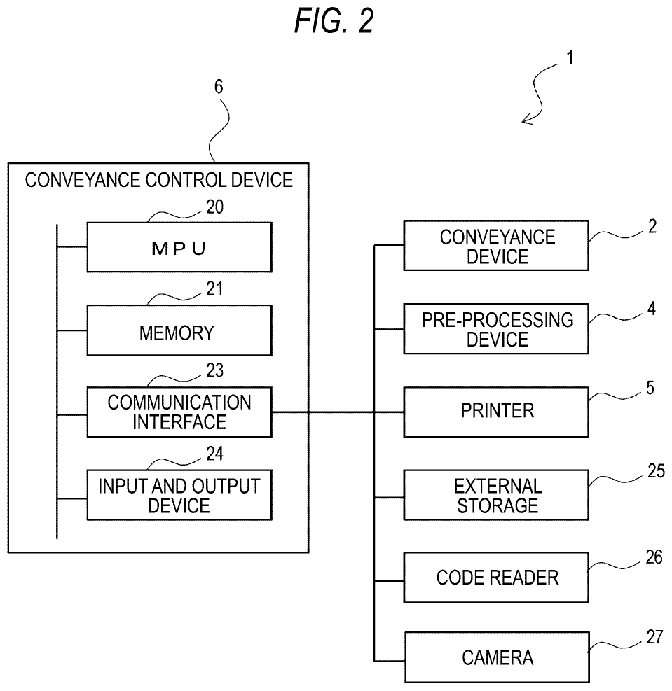

FIG. 2 is a block diagram showing a functional configuration of the printing system 1. As shown in FIG. 2, the conveyance control device 6 included in the printing system 1 includes a micro processing unit (MPU) 20 as an example of a computer, and further includes a memory 21 electrically connected to the MPU 20, a communication interface 23, an input and output device 24, or the like.

The memory 21 is an example of a storage device, and includes a ROM, a RAM, and the like. The read only memory (ROM) is a read only memory including a mask ROM, a PROM, and the like, and configured to store a computer program for performing various kinds of data processing, data referred to by the MPU 20 during data processing, and the like. The random access memory (RAM) is a readable and writable memory including a DRAM, an SRAM, or the like, is configured to temporarily store information created during data processing, and store history information to be described later.

The communication interface 23 is a connection device for communicably connecting the conveyance control device 6 to the conveyance device 2, the pre-processing device 4, the printers 5, and other external devices, and Ethernet and the like may be used as an example. Here, an external recording device 25, a code reader 26, and a camera 27 are provided as other external devices. The external recording device 25 is a readable and writable recording device such as a hard disc drive (HDD), and for example, a network drive configured to access the control device 6 via the communication interface 23 can be used. The code reader 26 is a reading device that includes, for example, a light emitting element and a light receiving element and is configured to read a one-dimensional or two-dimensional barcode. The camera 27 includes, for example, a CMOS sensor having a plurality of photodiodes, and is configured to capture an image of the recording medium M supported by the platen 3 at the start position P1.

The input and output device 24 is a device configured to receives an input operation of information by a user and output information to the user. Examples of the input and output device 24 include an output device such as a display (display device) or a speaker (audio output device), an input device such as a keyboard or a mouse having physical buttons, and a device serving as both the output device forming the display device such as a touch panel display and the input device.

In the printing system 1, the conveyance control device 6 (in particular, the MPU 20) is configured to control the operation of the conveyance device 2 to convey the platen 3 along the circulation line 2A and the branch lines 2B. The configuration of the platen 3 is not particularly limited as long as the platen 3 can be conveyed by the conveyance device 2 while appropriately supporting the recording medium M. Although only one platen 3 is shown in FIG. 1, a plurality of platens 3 conveyed by the conveyance device 2 are provided in the present disclosure. Hereinafter, the operation of the printing system 1 and the operation of the conveyance control device 6 will be described.

### <Operation of Printing System>

In the printing system 1 of the present disclosure, the user sets the recording medium M on the platen 3 at the start position P1. Accordingly, the recording medium M is supported on the platen 3 such that a portion on which an image is printed is an upper surface. Next, the user reads identification information from a tag or the like attached to the recording medium M by the code reader 26. The conveyance controller 6 is configured to receive a print job by reading the identification information. Then, the conveyance control device 6 is configured to refer to data stored in advance in the external storage device 25, read the print data and pre-processing data corresponding to the identification information, and determine an execution printer 5A which is one printer 5 configured to execute printing on the recording medium M.

The print data includes image data (for example, raster data) related to an image to be printed, print setting information related to a setting at the time of printing in the printer 5, or the like. Further, the pre-processing data includes pre-processing setting information related to a setting of the pre-processing to be executed by the pre-processing device 4.

The control device 6 is configured to transmit the pre-processing data to the pre-processing device 4 and transmit the print data to the execution printer 5A. Further, the conveyance control device 6 regards the reading of the identification information as a trigger to determine that the setting of the recording medium M on the platen 3 is completed, and starts the conveyance of the platen 3 by the conveyance device 2.

That is, the conveyance control device 6 is configured to convey the platen 3 in the counterclockwise direction from the start position P1 along the circulation line 2A shown in FIG. 1. Then, the pre-processing device 4 temporarily stops the platen 3 and executes predetermined pre-processing based on the pre-processing data. In a case where the pre-processing is completed, the platen 3 is conveyed in the counterclockwise direction along the circulation line 2A again, and further, the platen 3 is transferred to the predetermined branch line 2B, and the platen 3 is conveyed to the execution printer 5A located on a leading end side of the branch line 2B. In FIG. 1, the printer 5 located at the foremost position among the three printers 5 is the execution printer 5A.

In a case where the platen 3 reaches the execution printer 5A, printing processing is performed on the recording medium M supported by the platen 3. That is, the execution printer 5A is configured to eject ink from the head, based on the print data transmitted from the conveyance control device 6, to form an image on the recording medium M. In a case where the printing processing is completed, the platen 3 is conveyed to a base end side along the branch line 2B and is transferred to the circulation line 2A again. Thereafter, the platen 3 on which the recording medium M on which the image is printed is placed, is conveyed in the counterclockwise direction along the circulation line 2A and returns to the start position P1 where the platen 3 is collected by the user.

The above operation of the printing system 1 is an example, and is not limited thereto. For example, after the printing processing is completed, post-processing for fixing the ink on the recording medium M more quickly may be executed, or the pre-processing may be omitted. A collection position of the printed recording medium M may not be the start position P1, and a separate collection position may be provided between the execution printer 5A and the start position P1.

### <Operation of Conveyance Control Device>

The printing system 1 of the present disclosure includes the plurality of printers 5. In general, even in a printer of the same model, since the viscosity of the ink changes with time according to each use state, and ink ejection characteristics of the head also differ, a reproducible color gamut differs for each printer. Therefore, even when the same print job for printing the same image on the same medium is executed, if the printer 5 used is different, a difference may occur in the print result.

In the printing system 1 of the present disclosure, the conveyance control device 6 determines the execution printer 5A by a predetermined procedure, in order to improve color reproducibility of the printed image in a case where the same print job is executed. A plurality of types of modes are prepared for such determination processing. Hereinafter, an operation related to the determination of the execution printer 5A will be described for each mode. The mode in which the conveyance control device 6 operates as described below can be set in advance based on, for example, information input by the user operating the input and output device 24.

Hereinafter, in order to distinguish the three printers 5 shown in FIG. 1 from each other, the printers 5 are also referred to as a printer X, a printer Y, and a printer Z in order of proximity to the start position P1 in the forward direction. The printers X, Y, and Z are given identification information (ID) identifying each other, and the control device 6 is configured to identify the printers X, Y, and Z based on the ID. The ID is stored in, for example, the memory 21.

### <Regarding Image Quality Priority Mode>

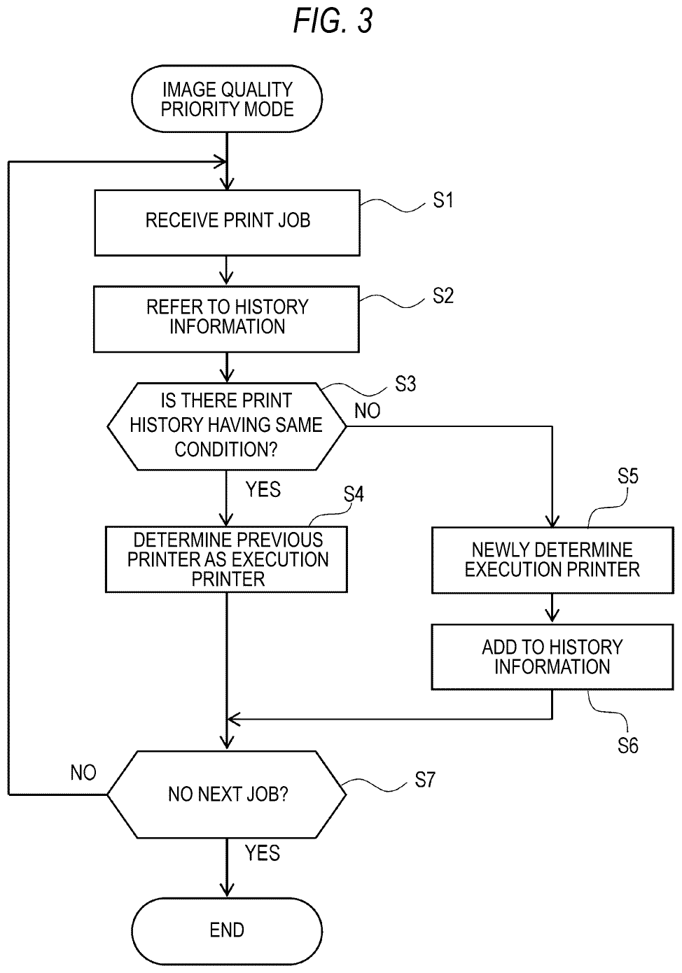

FIG. 3 is a flowchart showing an operation example of the conveyance control device 6 in an image quality priority mode. The image quality priority mode is an operation of the conveyance control device 6 aiming at achieving high image quality of a print result on the recording medium M with a highest priority in the execution of the print job.

As shown in FIG. 3, the conveyance control device 6 receives a print job (step S1). For example, as described above, after the user sets the recording medium M on the platen 3 at the start position P1, the identification information attached to the recording medium M is read by the code reader 26, thereby receiving the print job. Then, the conveyance control device 6 reads the print data and the pre-processing data corresponding to the identification information, from the external storage device 25, and receives them. That is, the reception of the print job (step S1) includes reception of the print data and the pre-processing data. The print data includes the image data and the print setting information, as described above.

Next, the conveyance control device 6 refers to the history information stored in the memory 21 (step S2). Here, the history information is information related to print history in which print data of printing executed in the past and the printer 5 executing printing based on the print data (more specifically, the ID given to the printer 5) are associated with each other. For example, in a case where an image A has been printed by the printer X which is one of the three printers 5 in the past, the history information including print history in which the image data indicating the image A and the ID of the printer X are associated with each other, is stored in the memory 21. Hereinafter, the print data included in the history information is referred to as “first print data”, and print data related to the print job newly received this time is referred to as “second print data”.

The conveyance control device 6 determines whether a print history having the same condition as that of the received print job is present in the history information (step S3). The “same condition” is an identity of the first print data and the second print data. More specifically, an identity of the images indicated by the image data included in each print data. Accordingly, in step S3, specifically, in a case where the second print data related to the print job received this time has a content of printing the image A, for example, it is determined whether print history in which the image A and any one of the printers 5 are associated with each other is present in the history information.

In a case where the print history having the same condition is present (step S3: YES), the printer 5 indicated by the print history is determined as the execution printer 5A, which is the printer 5 executing the current print job (step S4). On the other hand, in a case where the print history having the same condition is not present (step S3: NO), any one of the plurality of printers 5 is determined as the execution printer 5A (step S5). Then, the print history in which the second print data related to the current print job and the execution printer 5A determined in step S5 are associated with each other, is added to the history information and stored in the memory 21 (step S6).

In a case where the execution printer 5A for the current print job is thus determined (step S4, step S6), it is determined whether the next print job is present (step S7). In a case where the next print job is present (step S7: YES), the operation from step S1 is executed again, and in a case where the next print job is not present (S7: NO), the conveyance control device 6 stops the operation.

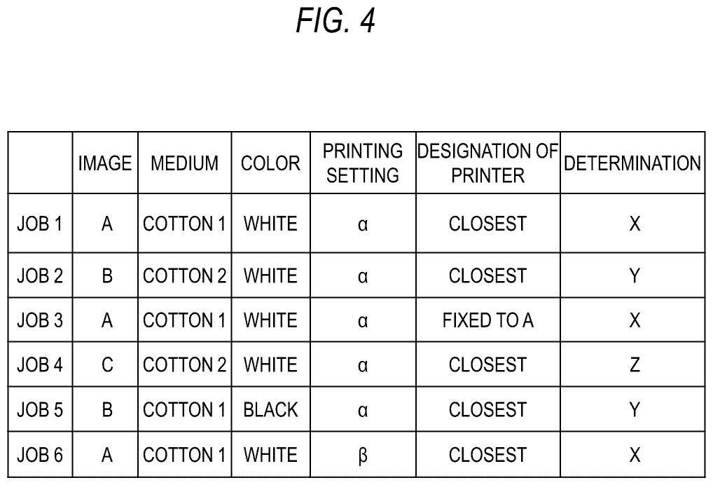

FIG. 4 is a table showing an example of a case where the execution printer 5A is determined for six print jobs according to the flowchart of FIG. 3. The six print jobs are a series of print jobs for which printing processing is scheduled to be continuously executed. In FIG. 4, for each print job, an “image” related to an image to be printed based on print data, a “medium” related mainly to the type of a material of the recording medium M, a “color” of the recording medium M, various “print settings”, and “designation of printer” are shown, and the printer determined in step S4 or step S5 of FIG. 3 is shown in a “determination” column.

A print job 1 is a job for printing the image A, and there is no print history having the same condition in the history information (step S3: NO). When the printer X is determined as the execution printer 5A (step S5), the print history is added to the history information (step S6). A determination method of the execution printer 5A in step S5 is not particularly limited, but a predetermined condition may be set in advance. In FIG. 4, as an example, the printer 5 closest to the start position P1 in the forward direction among the available (unused) printers 5 is selected as the execution printer 5A. For this reason, each printer 5 is configured to transmit status information of an own device including whether the own device is used at least at a predetermined timing (a predetermined cycle or the like) to the conveyance control device 6, and the conveyance control device 6 is configured to grasp a status of each printer 5 based on the received status information. Further, the status of each printer 5 is grasped by the conveyance control device 6 from a time point before the platen 3 is conveyed from the start position P1.

A print job 2 is a job for printing an image B, and there is no print history having the same condition in the history information (step S3: NO). Further, it is assumed that the printer X is in use for the execution of the previous print job 1 at a timing of starting the execution of the print job 2. In this case, in a case where the printer Y that is the closest among the available printers is determined as the execution printer 5A of the print job 2 (step S5), the print history is added to the history information (step S6).

A print job 3 is a job for printing the image A, and the print history of the print job 1 having the same condition is present in the history information (step S3: YES). In this case, the printer X associated with the print data of the print job 1 related to the same condition in the history information is determined as the execution printer 5A of the print job 3 (step S4).

A print job 4 is a job for printing an image C, and there is no print history having the same condition in the history information (step S3: NO). Further, it is assumed that the printers X, Y are in use for the execution of the previous print jobs 2, 3 at a timing of starting the execution of the print job 4. In this case, when the remaining available printer Z is determined as the execution printer 5A of the print job 4 (step S5), the print history is added to the history information (step S6).

A print job 5 is a job for printing the image B, and the print history of the print job 2 having the same condition is present in the history information (step S3: YES). In this case, the printer Y associated with the print data of the print job 2 related to the same condition in the history information is determined as the execution printer 5A of the print job 5 (step S4).

A print job 6 is a job for printing the image A, and the print history of the print job 3 having the same condition is present in the history information (step S3: YES). In this case, the printer X associated with the print data of the print job 3 related to the same condition in the history information is determined as the execution printer 5A of the print job 6 (step S4).

The processing of determining the execution printers 5A for the print jobs 1 to 6 is performed, as an example, after the series of print jobs 1 to 6 are collectively received and before the conveyance of the platen 3 is started corresponding to the first print job 1 from the start position P1. In this case, by calculating time required for the print job (typically, the time required for conveyance, pre-processing, and printing) from the image data and the pre-processing setting information included in the print data of the print job, it is possible to simulate the availability of each printer 5, that is, the availability of a printer at the start of execution of a certain print job.

As described above, the conveyance control device 6 according to the present disclosure uses the same printer 5 as that used in the past print job when the print job having the same condition as that of the past print job based on the history information is executed. Accordingly, it is possible to further improve the color reproducibility of the printed image when the same job is executed.

As in the case of the print job 6 in FIG. 4, in a case where a plurality of past print jobs related to the same condition with respect to the print job received this time are present (print jobs 1, 3), the history information related to the print job executed most recently (print job 3) may be referred to. However, the present invention is not limited thereto, and the history information related to the oldest print job among the plurality of print jobs related to the same condition may be referred to, or another condition may be set and the history information related to the print job corresponding to the condition may be referred to.

### <Modification 1>

The identity between the first print data and the second print data may be a complete match, or may be regarded as the same as long as a predetermined condition is satisfied even when the first print data and the second print data do not complete match. For example, the image data included in the first print data and the image data included in the second print data may be compared, and when a degree of similarity therebetween is equal to or greater than a predetermined value, both print data may be regarded as the same.

For example, coordinates and a color value (for example, an RGB value) of each pixel forming the image are acquired from the image data of the first print data. Similarly, the coordinates and the color value of each pixel forming the image are acquired from the image data of the second print data. Then, a difference value (first total difference value) of the whole image is acquired by acquiring a difference between color values of corresponding pixels for all the pixels. In a case where the first total difference value is less than a predetermined threshold set in advance, it can be determined that the degree of similarity is equal to or greater than the predetermined value (the same), and when the first total difference value is equal to or greater than the threshold, it can be determined that the degree of similarity is less than the predetermined value (not the same).

A determination method of the similarity is not limited thereto. For example, respective averages of the RGB values of the whole image may be calculated based on the first print data and the second print data, and in a case where a difference value between the two average values is equal to or less than a predetermined value, it may be determined that the first print data and the second print data are the same. Further, a histogram having an R value, a G value, and a B value as bins may be created based on the first print data and the second print data, and in a case where the difference of bins between both data is equal to or less than a predetermined value, it may be determined that the first print data and the second print data are the same. Further, matching may be performed on corresponding feature portions extracted from the first print data and the second print data, respectively, and it may be determined that the first print data and the second print data are the same in a case where a distance therebetween in a predetermined color space is equal to or less than a predetermined value.

### <Modification 2>

An example in which determination processing of the execution printer 5A is determined based on the identity of the image data has been described in the above description, but the present invention is not limited thereto. For example, the execution printer 5A may be determined based on the identity of the recording medium M in addition to the identity of the image data.

For example, in the history information stored in the memory 21, information (first medium information) related to the type of the recording medium M on which printing based on the first print data is executed is also associated with the first print data. On the other hand, in a case where a print job is newly received, information (second medium information) related to the type of the recording medium M on which an image is printed in the print job is acquired. Only in a case where the first image data matches the second image data and the first medium information matches the second medium information, it may be determined that there is print history under the same condition (step S3: YES).

That is, even in a case where images to be printed are the same, there is a possibility that print results may be different when the types of the recording medium M on which printing is executed are different. Accordingly, in a case where the types of the recording medium M are different, the execution printer 5A can be determined from among the available printers 5 without being based on the history information. The second medium information may be obtained by capturing an image of the recording medium M by the camera 27 when the recording medium M is set on the platen 3 and analyzing the captured image by the conveyance control device 6. Alternatively, the second medium information may be input by a user via the input and output device 24 or may be included in the print setting information provided in the print data.

### <Modification 3>

In the above description, an example is described in which, in a case where there is no print history related to the same condition in the history information (step S3: NO), the printer 5 closest to the start position P1 in the forward direction among the available printers 5 is selected as the execution printer 5A under the predetermined condition. Alternatively, one printer 5 among the available printers 5 may be determined as the execution printer 5A, based on color reproducibility when a print job received this time is executed.

For example, for each of the printers 5, a color gamut reproducible by printing is acquired, and a color gamut for image data of received second print data is acquired. Both color gamuts are converted into Lab values and compared, and the difference value for each pixel is added to acquire a second total difference value. The printer 5 having the smallest second total difference value may be determined as the execution printer 5A.

### <Regarding Speed Priority Mode>

According to the operation example in the image quality priority mode of FIG. 3 described above, regarding the print data under the same condition, since the printing is performed by the same printer 5, the image quality of the print result can be made uniform. On the other hand, in a case where the execution printer 5A is determined in step S4 (for example, see the print jobs 3, 5, and 6 in FIG. 4), the execution printer 5A may be in use by a preceding print job at the start of execution of the print job. In this case, since it is necessary to wait until the execution printer 5A becomes available, it may take a long time from the start to the end of the series of print jobs.

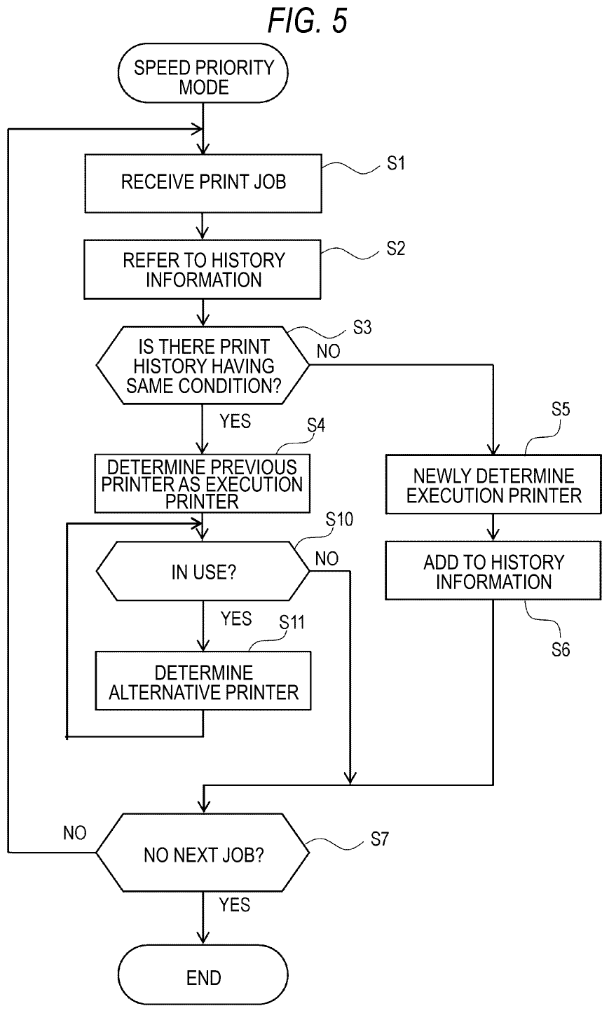

The conveyance control device 6 is configured to operate not only in the image quality priority mode but also in the speed priority mode. FIG. 5 is a flowchart showing an operation example of the conveyance control device 6 in the speed priority mode. The speed priority mode is an operation of the conveyance control device 6 aiming at shortening the time required from the start to the end of a series of print jobs in the execution of the print jobs. Therefore, in the speed priority mode, in a case where the execution printer 5A determined in step S4 of FIG. 3 is in use, the conveyance control device 6 does not wait until the execution printer 5A becomes available, but determines another printer 5 as an alternative printer 5B.

An example will be described below. In the flowchart shown in FIG. 5, processing of steps S1 to S7 similar to those in FIG. 3 is included, and processing of steps S10 to S11 executed after the processing of step S4 is included. Since processing contents of steps S1 to S7 are similar to those described with reference to FIG. 3, description thereof will be omitted, and the processing of steps S10 to S11 will be described below.

After determining the execution printer 5A in step S4, the conveyance control device 6 determines whether the execution printer 5A is in use (step S10). For example, since the print job 3 in FIG. 4 has the same condition as that of the print job 1, the printer X is determined as the execution printer 5A in step S4, and there is a possibility that the printer X is in use for the preceding print job 1. Whether the printer X is in use can be grasped by the conveyance control device 6 based on the status information sent from each printer 5 as described above.

In a case where it is determined that the printer X is not in use (step S10: NO), the processing proceeds to step S7. On the other hand, in a case where it is determined that the printer X is in use (step S10: YES), the CPU 11 executes determination processing of the alternative printer 5B (step S11). A determination method of the alternative printer 5B is not particularly limited, and one printer 5 among the printers 5 other than the execution printer 5A may be determined as the alternative printer 5B.

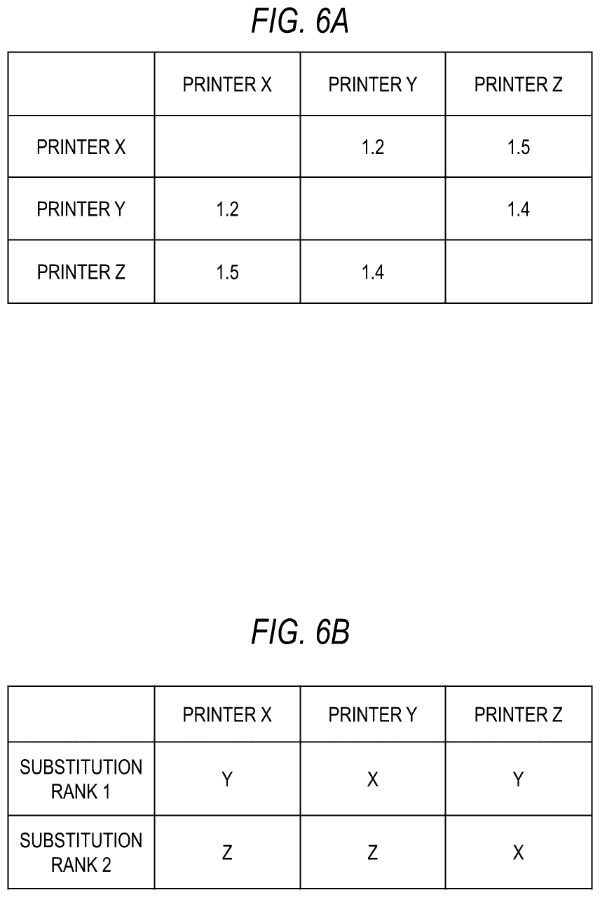

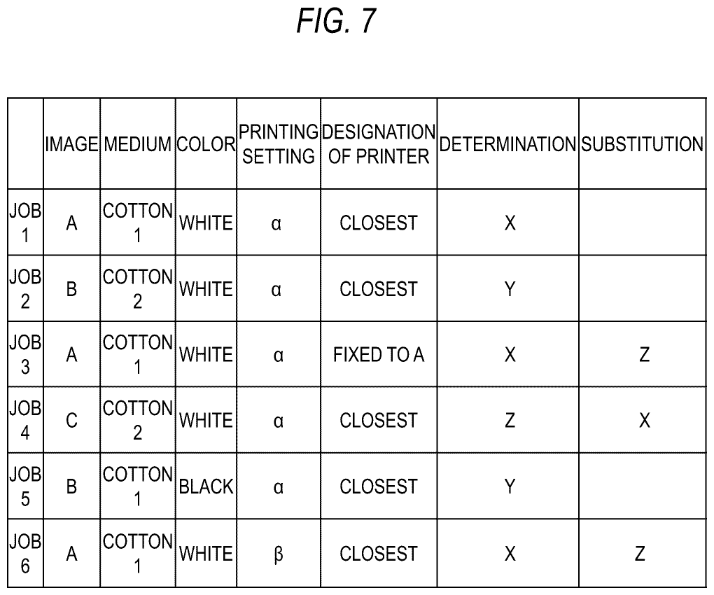

As an example, a determination method of one printer 5 selected based on a comparison result of a color gamut with the execution printer 5A as the alternative printer 5B is exemplified. This method will be further described with reference to FIGS. 6A, 6B, and 7. FIG. 6A is a table showing comparison results of color gamuts among the plurality of printers 5, and FIG. 6B is a table showing substitution ranks among the plurality of printers 5. FIG. 7 is a table showing an example when the execution printer 5A and the alternative printer 5B are determined according to the flowchart of FIG. 5.

As shown in FIG. 6A, a degree of approximation of the color gamut between any two of the printers X, Y, and Z, which are the plurality of printers 5, is calculated in advance. For example, in a case where two printers 5 are targeted, a degree of approximation can be obtained by dividing a volume occupied by the entire color gamut of one printer 5 in a Lab space by a volume occupied by the color gamuts of the two printers 5 that completely match. In this case, the degree of approximation when the color gamuts of the two printers 5 completely match is [1.0], and the degree of approximation increases as the matching rate decreases.

In the case of FIG. 6A, a degree of approximation between the printers X and Y is [1.2], a degree of approximation between the printers Y and Z is [1.4], and a degree of approximation between the printers Z and X is [1.5]. Accordingly, as shown in FIG. 6B, the printer 5 replacing the printer X has the printer Y as a first rank and the printer Z as a second rank. The printer 5 replacing the printer Y has the printer X as the first rank and the printer Z as the second rank, and the printer 5 replacing the printer Z has the printer Y as the first rank and the printer X as the second rank. The memory 21 stores information (alternative printer information) indicating the substitution ranks among the plurality of printers 5 corresponding to FIG. 6B.

The printers 5 corresponding to the series of print jobs 1 to 6, which are determined using the determination method of the alternative printer 5B, will be described with reference to FIG. 7. In FIG. 7, for the print jobs 1 and 2, the printers X and Y are determined as the execution printers 5A, respectively, in step S5 of FIG. 3 as in the case of FIG. 4. Next, it is assumed that, for the print job 3, the printer X determined as the execution printer 5A in step S4 of FIG. 3 is in use for the preceding print job 1 (step S10: YES). In this case, the conveyance control device 6 refers to the alternative printer information stored in the memory 21, and acquires the printer 5 having the first substitution rank for the printer X.

In the case of FIG. 6B, the printer Y having the first substitution rank is acquired as the alternative printer 5B. However, as can be seen from FIG. 7, the printer Y is also in use for the preceding print job 2 (step S10: YES). Accordingly, the printer 5 having the second rank in the substitution rank is acquired with reference to the alternative printer information in the memory 21 again. In the case of FIG. 6B, the printer Z having the second substitution rank is newly acquired as the alternative printer 5B. Since the printer Z is available at the start of execution of the print job 3 (step S10: NO), the printer Z is determined as the alternative printer 5B.

Here, in a case where the printer 5 used in a certain print job is replaced with the alternative printer 5B instead of the execution printer 5A, the determination of the printer 5 used in the subsequent print jobs is also affected. For example, also in the case of FIG. 7, as a result of the printer X of the printer 5 used in the print job 3 being determined as the alternative printer 5B, the determination of the printer 5 used in the next print job 4 is affected.

For example, for the print job 4, the printer Z is determined as the execution printer 5A in step S4, but since the printer Z is determined as the alternative printer 5B in the print job 3, the printer Z is in use at the start of execution of the print job 4 (step S10: YES). Therefore, the conveyance control device 6 refers to the alternative printer information in the memory 21, and acquires the printer X having the first substitution rank for the printer Z as the alternative printer 5B (step S11).

Further, in the case of FIG. 7, for the print job 6, the printer X is determined as the execution printer in step S4, and the printer X is the alternative printer 5B in the print job 4. Therefore, the printer X is in use at the start of execution of the print job 6 (step S10: YES). Accordingly, the conveyance control device 6 refers to the alternative printer information in the memory 21, and acquires the printer Y having the first substitution rank for the printer X as the alternative printer 5B (step S11). However, since the printer Y is also in use for the print job 5 (step S10: YES), the alternative printer information is referred to again, and the printer Z having the second substitution rank is newly acquired as the alternative printer 5B (step S11). Since the printer Z is available at the start of execution of the print job 6 (step S10: NO), the printer Z is determined as the alternative printer 5B.

As described above, in the speed priority mode, the execution printer 5A is basically determined similarly to the image quality priority mode, so that the image quality of the print result is made uniform. On the other hand, in the speed priority mode, when a waiting time occurs until the execution of the print job is started as the execution printer 5A is in use, the alternative printer 5B is determined instead of the execution printer 5A, and the print job is executed by the alternative printer 5B. Accordingly, the occurrence of the waiting time can be suppressed, and the time required for the series of print jobs can be shortened.

### <Regarding Compromise Mode>

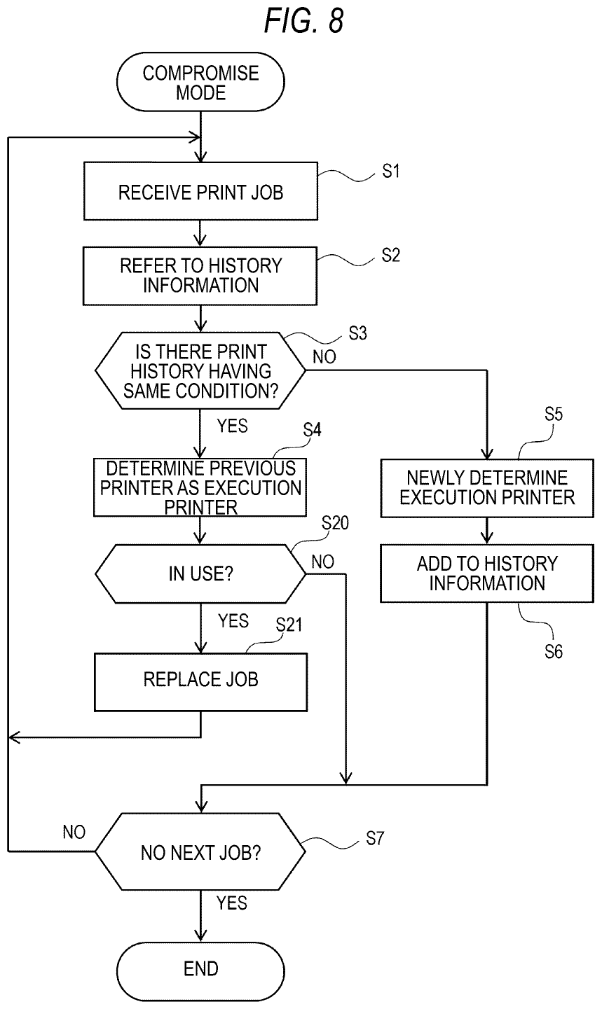

FIG. 8 is a flowchart showing an operation example of the conveyance control device 6 in a compromise mode. The compromise mode is an operation of the conveyance control device 6 aiming at both of the uniformity of the image quality and the shortening of the time required for a series of print jobs in the execution of the print jobs. Therefore, in the compromise mode, in a case where the execution printer 5A determined in step S4 of FIG. 3 for a certain print job is in use at the start of execution of the print job, the conveyance control device 6 determines the execution printer 5A for performing printing based on second print data related to another newly received print job based on the history information and the second print data.

Hereinafter, description will be made in detail. As shown in FIG. 8, in this mode, processing of steps S1 to S7 similar to those in FIG. 3 is included, and processing of steps S20 to S21 executed after the processing of step S4 is included. Since processing contents of steps S1 to S7 are similar to those described with reference to FIG. 3, description thereof will be omitted, and processing of steps S20 and S21 will be described below.

After determining the execution printer 5A in step S4, the conveyance control device 6 determines whether the execution printer 5A is in use (step S20). This determination processing is similar to step S10 of FIG. 5 related to the speed priority mode. In a case where it is determined that the printer 5A is not in use (step S20: NO), the processing proceeds to step S7. On the other hand, in a case where it is determined that the printer 5A is in use (step S20: YES), job replacement processing is executed (step S21).

As an example, referring to the series of print jobs shown in FIG. 4, it is assumed that, for the print job 3, the printer X determined as the execution printer 5A in step S4 of FIG. 3 is in use for the preceding print job 1 (step S20: YES). In this case, the conveyance control device 6 changes an execution order of the jobs and changes the execution order of the jobs such that the print job 4 precedes the print job 3 (step S21). Then, the processing from step S1 is executed in the order of the print job 4 and the print job 3, and the respective execution printers 5A are determined. The same applies to the print job 5 and subsequent jobs.

As described above, in the compromise mode, the execution printer 5A is basically determined similarly to the image quality priority mode, so that the image quality of the print result is made uniform. When the determined execution printer 5A is in use and the waiting time occurs, the execution order of the print jobs is changed, and the execution printer 5A is determined for another print job. Accordingly, it is possible to achieve both the uniformity of the image quality of the print result and the suppression of the occurrence of the waiting time.

### <Regarding User Selection Mode>

In each of the above-described modes, the execution printer 5A and the alternative printer 5B are basically determined by the conveyance control device 6, and the determination of the printer 5 to be used in the execution of the series of print jobs may be made by the user. Hereinafter, the user selection mode in which the user determines the printer 5 will be described.

The user selection mode described here is executed, for example, in a case where the execution printer 5A is determined in the image quality priority mode and the execution printer 5A related to a certain print job is in use for the preceding print job at the start of execution of the print job. That is, in a case where the waiting time occurs when the execution printer 5A is determined in the image quality priority mode, the user can select based on which mode of the image quality priority mode and the speed priority mode the execution printer 5A or the alternative printer 5B is finally determined.

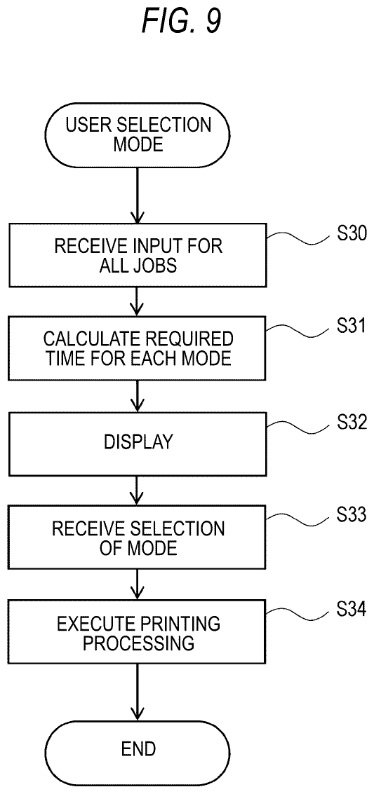

FIG. 9 is a flowchart showing an operation example of the conveyance control device 6 in the user selection mode. As shown in FIG. 9, the conveyance control device 6 receives inputs for all of the series of print jobs (step S30). Then, the required time for each mode is calculated based on the received print data of all the print jobs (step S31), and the calculation result is output (displayed) to the user by the input and output device 24 (step S32). In a case where the user operates the input and output device 24 to perform an input to select one of the modes, the conveyance control device 6 receives input information, that is, selection of the mode (step S33). Then, the execution printer 5A or the alternative printer 5B is determined for each print job based on the received mode, and the printing processing is executed for the series of print jobs (step S34).

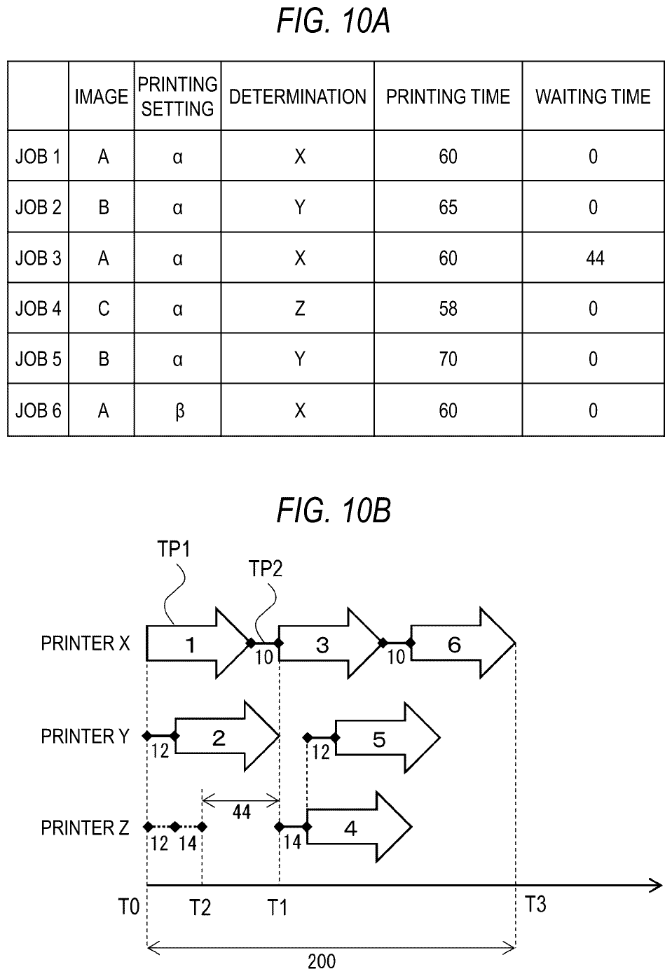

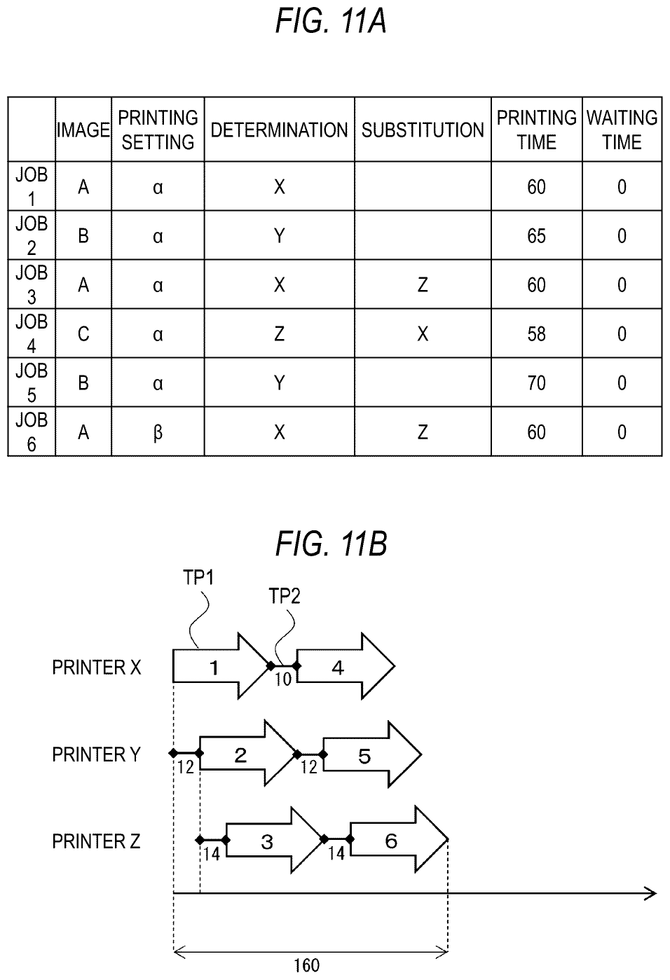

The calculation of the required time for each mode in step S31 will be further described with reference to FIGS. 10A, 10B, and 11. FIGS. 10A and 10B are a table and a time chart for illustrating required time when the series of print jobs are executed in the image quality priority mode. Contents of items of “image”, “print setting”, and “determination” for each of the print jobs 1 to 6 shown in FIG. 10A are the same as those shown in the table of FIG. 4 used in the description of the image quality priority mode.

As illustrated in the item of “printing time” in FIG. 10A, the conveyance control device 6 acquires printing time which is time required to print an image for each of the print jobs 1 to 6. The printing time can be calculated from the image data included in the print data of each print job. In the example shown in FIG. 10A, the printing time of the print jobs 1, 3, 6 for printing the image A is 60 seconds, the printing time of the print job 2 for printing the image B is 65 seconds, and the printing time of the print job 4 for printing the image C is 58 seconds. In the print job 5, the image B is printed, but as shown in FIG. 4, the color of the recording medium M is black unlike the case of the print job 2, and it is necessary to print the base color, and thus the printing time is 70 seconds, which is correspondingly longer.

In FIG. 10B, a horizontal axis represents time, a white arrow TP1 represents the length of time required for the printing processing in each print job, and numbers 1 to 6 in the white arrows TP1 represent the correspondence relationship with the print jobs 1 to 6. Each white arrow TP1 is displayed beside the printer used in the corresponding print job among the printers X to Z. A line segment TP2 with rectangular dots at both ends represents convey time of a platen 14 from the start position P1 to each printer 5, and a number attached below the line segment TP2 represents a specific number of seconds of the convey time. In the example described here, for the reason of a configuration of the conveyance device 15, there is only one platen 14 capable of simultaneously conveying the sheet P on the circulation line 2A toward the printer 5.

Accordingly, in the case of FIG. 10B, after printing of the print job 1 by the printer X is started at time T0, the conveyance of the platen 14 to the printer Y is started, and after 12 seconds, printing of the print job 2 by the printer Y is started. Next, after the printing of the print job 1 ends, the conveyance of the platen 14 for the print job 3 is started, and 10 seconds later, printing of the print job 3 by the printer X is started. After the start of printing of the print job 3, the conveyance of the platen 14 for the print job 4 is started, and 14 seconds later, printing of the print job 4 by the printer Z is started.

Further, after the start of printing of the print job 4, the conveyance of the platen 14 for the print job 5 is started, and 12 seconds later, printing of the print job 5 by the printer Y is started. After the printing of the print job 3 ends, the conveyance of the platen 14 for the print job 6 is started, and 10 seconds later, printing of the print job 6 by the printer X is started.

As a result, the series of print jobs related to the print jobs 1 to 6 start at the start of printing (time TO) for the print job 1 by the printer X, and end at the end of printing (time T3) for the print job 6 by the printer X. Accordingly, the required time for all the processing until the end of all of the series of print jobs is 200 seconds (=60 seconds+10 seconds+60 seconds+10 seconds+60 seconds). For the print job 3, the waiting time occurs before the start of printing. Specifically, as shown in FIG. 10B, the start of printing for the print job 3 is time T1 after 70 seconds (60 seconds+10 seconds) from the time TO. On the other hand, in a case where the printing for the print job 3 is executed by the temporarily available printer Z, start time T2 is 26 seconds after the time T0 (=12 seconds+14 seconds). Accordingly, it can be seen that waiting time of 44 seconds (=70 seconds-26 seconds) occurs between the time T1 and the time T2 at the time of executing the print job 3.

Next, calculation of the required time in the speed priority mode will be described. FIGS. 11A and 11B are a table and a time chart for illustrating the required time when the series of print jobs are executed in the speed priority mode. Contents of items of “image”, “print setting”, and “determination” for each of the print jobs 1 to 6 shown in FIG. 11A are the same as those shown in the table of FIG. 7 used in the description of the speed priority mode.

In the case of FIG. 11B, after the printing of the print job 1 by the printer X is started at the time T0, the conveyance of the platen 14 to the printer Y is started, and 12 seconds later, the printing of the print job 2 by the printer Y is started. Here, as shown in FIG. 11A, for the print job 3, since the printer X which is the execution printer 5A is in use, the printer Z is the alternative printer 5B. Accordingly, after the printing of the print job 2 by the printer Y is started, the conveyance of the platen 14 to the printer Z is started, and 14 seconds later, the printing of the print job 3 by the printer Z is started.

Next, when the printing of the print job 1 by the printer X ends, the conveyance of the platen 14 to the printer X is started, and 10 seconds later, the printing of the print job 4 by the printer X is started. In the print job 4, the printer X is the alternative printer 5B. Next, when the printing of the print job 2 by the printer Y ends, the conveyance of the platen 14 to the printer Y is started, and 12 seconds later, the printing of the print job 5 by the printer Y is started. Similarly, when the printing of the print job 3 by the printer Z ends, the conveyance of the platen 14 to the printer Z is started, and 14 seconds later, the printing of the print job 6 by the printer Z is started. In the print job 6, the printer Z is the alternative printer 5B.

As a result, the print jobs related to the print jobs 1 to 6 start at the start of printing (time T0) for the print job 1 by the printer X, and end at the end of printing (time T4) for the print job 6 by the printer Z. Accordingly, the required time for all the processing until the end of all of the series of print jobs is 160 seconds (=12 seconds+14 seconds+60 seconds+14 seconds+60 seconds). On the other hand, in the case of FIG. 11B, no waiting time occurs.

In step S31 of the user selection mode, the required time of each mode is calculated as described above as an example. Then, in step S32, the calculated time is displayed. The information to be displayed is not limited to the required time for all the processing for each mode, and the waiting time may also be displayed.

As described above, by displaying the required time for each mode and receiving the mode selection by the user, the printer 5 to be used in each print job can be determined in the mode desired by the user. Therefore, it is possible to reflect the user's request when executing the print job.

The functions of the disclosed elements can be implemented by using various processors and circuits configured or programmed to execute the functions described above. The processor can be regarded as a circuit, and the circuit, the unit, the means, and the like disclosed in this specification are hardware that executes the functions described above or hardware programmed to execute the functions.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents.

### INDUSTRIAL APPLICABILITY

The present disclosure can be applied to a conveyance control device, a control method thereof, and a computer program that can further improve color reproducibility of a printed image in a case where the same job is executed when a platen is conveyed to a plurality of printers.

What is claimed is:

1. A conveyance control device comprising:
a memory; and
a processor configured to control a conveyance device in a printing system, the printing system including:
a plurality of printers, each of the printers being configured to perform printing on a recording medium based on print data; and
the conveyance device configured to convey, to any one of the plurality of printers, a platen on which the recording medium is placed;
wherein the memory is configured to store computer-readable instructions that, when executed by the processor, cause the processor to perform processes including:
receiving second print data included in the print data; and
determining, among the plurality of printers, an execution printer that is a printer performing printing based on the second print data, based on the received second print data and history information stored in a storage, the storage being configured to store the history information in which first print data and the printer are associated with each other, the first print data being included in the print data, the printer performing the printing based on the first print data.

2. The conveyance control device according to claim 1,
wherein in a case where a degree of similarity between the first print data and the second print data is equal to or greater than a predetermined value, the processor determines, as the execution printer, the printer associated with the first print data in the history information.

3. The conveyance control device according to claim 2,
wherein in a case where the first print data having the degree of similarity with the second print data equal to or greater than the predetermined value is not present in the history information, the processor determines, among the plurality of printers, the execution printer based on color reproducibility of the second print data in a print result on the recording medium.

4. The conveyance control device according to claim 1,
wherein the history information includes first medium information associated with the first print data, the first medium information being information related to a recording medium on which printing based on the first print data is performed, and
the processor is configured to
acquire second medium information from an image obtained by capturing an image of the recording medium placed on the platen with a camera; and
determine the execution printer based on the acquired second medium information, the second print data, and the history information, the second medium information being information related to the recording medium.

5. The conveyance control device according to claim 1,
wherein in a case where the execution printer determined based on the second print data and the history information is in a state where the printing based on the second print data cannot be performed, the processor determines one printer as an alternative printer, the one printer being selected based on a comparison result of each color gamut between the execution printer and a printer other than the execution printer among the plurality of printers, the alternative printer being a printer performing the printing based on the second print data, instead of the execution printer.

6. The conveyance control device according to claim 1,
wherein in a case where the execution printer determined based on the second print data and the history information is in a state where the printing based on the second print data cannot be performed, the processor determines the execution printer based on an other second print data newly received and the history information, the execution printer being for performing the printing based on the other second print data.

7. The conveyance control device according to claim 1,
wherein in a case where the execution printer determined based on the second print data and the history information is in a state where the printing based on the second print data cannot be performed, the processor causes a display to display a selection indicating one or a plurality of pieces of processing executable by the printing system and information related to time required for each piece of processing.

8. A control method of a conveyance control device, the conveyance control device including:
a processor configured to control a conveyance device in a printing system, the printing system including:
a plurality of printers, each of the printers being configured to perform printing on a recording medium based on print data; and
the conveyance device configured to convey, to any one of the plurality of printers, a platen on which the recording medium is placed,
the control method comprising:
receiving second print data included in the print data; and
determining, among the plurality of printers, an execution printer that is a printer performing printing based on the second print data, based on the received second print data and history information stored in a storage, the storage being configured to store the history information in which first print data and the printer are associated with each other, the first print data being included in the print data, the printer performing the printing based on the first print data.

9. A non-transitory computer readable storage medium storing a computer program executed by a processor in a conveyance control device including:
the processor configured to control a conveyance device in a printing system, the printing system including:
a plurality of printers, each of the printers being configured to perform printing on a recording medium based on print data; and
the conveyance device configured to convey, to any one of the plurality of printers, a platen on which the recording medium is placed,
the computer program causing the processor to:
receive second print data included in the print data; and
determine, among the plurality of printers, an execution printer that is a printer performing printing based on the second print data, based on the received second print data and history information stored in a storage, the storage being configured to store the history information in which first print data and the printer are associated with each other, the first print data being included in the print data, the printer performing the printing based on the first print data.
